(19) United States
(12) Patent Application Publication
(10) Pub. No.: US 2009/0120913 A1
(43) Pub. Date: May 14, 2009

(54) System for and Method of Producing Invisible Projection Welds

(75) Inventor: Alexander D. Khakhalev, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/937,518

(22) Filed: Nov. 9, 2007

(51) Int. Cl. B23K 11/06; B23K 11/16

(52) U.S. Cl. 219/83; 219/117.1; 219/118

(57) ABSTRACT

A system for and method of producing invisible welds for a plurality of workpieces, includes the steps of selecting a free-body projection, fixedly securing the projection intermediate the workpieces, and engaging the workpieces with a resistance welding apparatus such that the projection fuses to form the weld joint, and preferably, further includes autonomously securing the projection and an encircling portion of an adhesive tape intermediate the workpieces utilizing a roll dispenser, so as further cause to form an adhesive seal around the weld, and engaging the workpieces with modified electrodes having enlarged workpiece engaging faces over optimized weld force only application and weld force plus electric current application periods.

### BACKGROUND OF THE INVENTION

1. Field of the Invention

The present invention relates to resistance welding systems and methods, and more particularly concerns a resistance welding system for and method of invisibly welding a plurality of workpieces utilizing a free-body projection interposed therebetween.

2. Discussion of Prior Art

Resistance mash welding (e.g., conventional spot or seam welding) remains the most common method of joining metallic workpieces in various industries, including automotive manufacture and construction. In this method, the workpieces 1,2 are typically secured in a fixed condition, and then engaged by two electrodes 3,4, as shown in FIG. 1. The electrodes 3,4 function to co-extensively transmit a sustained force and an electric current through the workpieces until the combined resistance at their interface generates sufficient heat energy to produce a molten weld pool therebetween. Undesirably, however, exterior anomalies and aesthetic concerns are also often experienced. For example, depressions 5 caused by the force exuded upon the workpieces (FIG. 1a), whiskers (i.e., short pieces of material sticking through the root side of the weld joint), and spatters (i.e., satellites formed by loose droplets of molten material during welding) are just a few of the common by-products of resistance welding processes.

These aesthetic concerns are typically addressed during a finishing process, wherein depressions are filled and surfactants are milled prior to painting. Invariably, however, these finishing processes result in increased costs, including but not limited to additional material and labor. The need to address aesthetic concerns also results in a longer period of manufacture, thereby impacting productivity. Finally, even where a finishing process is provided, traces of the exterior anomalies remain and are often easily detectable through the paint.

More recently, various methods of metallurgically joining workpieces have been developed that utilize other less aesthetically impacting technology, such as thermal laser brazing, solid state (e.g., friction, ultrasonic, or explosive) welding, or diffusion bonding. It is appreciated, however, that these methods present more complex and therefore costly technologies in comparison to conventional resistance welding. As such, these technologies have achieved limited market penetration and are relegated to relatively small subsets of applications.

Thus, there remains a need in the art for a facilely implemented method of resistance welding a plurality of workpieces that reduces and more preferably eliminates exterior surface anomalies and aesthetic concerns.

### BRIEF SUMMARY OF THE INVENTION

Responsive to these concerns, an improved method of resistance welding a plurality of workpieces that eliminates exterior surface anomalies is presented. The inventive system and method disclosed herein is useful among other things for providing a facilely implemented solution that requires no new or additional resistance welding equipment. The method is useful for producing invisible fusion welds, which makes it ideal for exterior product welds (i.e., welds wherein the exterior surface of one or both of the engaged workpieces present an exterior product surface). It is appreciated that decreasing the amount of and more preferably eliminating exterior surface anomalies reduces the need for and extent of a finishing process, and thereby results in a reduction of the afore-mentioned costs.

The method generally consists of multiple steps, including selecting a free-body projection material and configuration based on the physical and chemical properties of the workpieces, and producing a projection in accordance therewith. Next, the projection is positioned in a desired weld position intermediate and spaced from the peripheral edges of the workpieces. The projection and workpieces are then secured in a fixed relative condition, such that the projection contacts the workpieces opposite their exterior engaging surfaces defining at least one axis of engagement. Finally, the workpieces are engaged along the axis by a resistance welding apparatus, so as to deform and fuse only the projection.

Other aspects and advantages of the present invention, including preferred welding apparatus and projection configurations, as well as preferred methods of placing the projection and performing the associative weld will be apparent from the following detailed description of the preferred embodiment(s) and the accompanying drawing figures.

### BRIEF DESCRIPTION OF THE SEVERAL VIEWS OF THE DRAWING

Preferred embodiments of the invention are described in detail below with reference to the attached drawing figures, wherein:

FIG. 1 is an elevation view of a prior art resistance spot welding apparatus and a plurality of workpieces, in a before welding condition;

FIG. 1a is an elevation view of the prior art apparatus and the workpieces shown in FIG. 1, in an after welding condition, particularly illustrating exterior surface depressions;

FIG. 1b is an elevation view of a welding apparatus adapted for use with the present invention, particularly illustrating a rapid follow-up cylinder and “C”-shaped structural frame;

FIG. 2 is an elevation view of a resistance welding system in accordance with a preferred embodiment of the present invention, wherein a free-body projection presenting a circular cross-sectional configuration is intermediately positioned between first and second workpieces;

FIG. 2a is an elevation view of the system shown in FIG. 2, after the welding force and before the current load have been applied to the workpieces and projection;

FIG. 2b is an elevation view of the system shown in FIG. 2, after the welding force and current load have been applied to the workpieces and projection;

FIG. 3 is an elevation view of a free-body projection having spaced top and bottom curvilinear surfaces in accordance with a preferred embodiment of the present invention, intermediately positioned between first and second workpieces;

FIG. 4 is a perspective view of a free-body projection having a diamond cross-section with chamfered edges in accordance with a preferred embodiment of the present invention engaged by a dual-electrode welding apparatus (in partial view), particularly illustrating projection-workpiece (interior) and electrode-workpiece (exterior) interfaces, b and a, respectively;

FIG. 4a is an elevation view of the projection and workpieces shown in FIG. 4, particularly illustrating the projection intermediately positioned between first and second workpieces;

FIG. 5 is a perspective view of an annular projection having a square horizontal cross-section, in accordance with a preferred embodiment of the present invention;

FIG. 6 is a perspective view of an annular projection having a circular horizontal cross-section, in accordance with a preferred embodiment of the present invention;

FIG. 7 is a perspective view of a free-body projection having an “H”-shaped vertical cross-section, in accordance with a preferred embodiment of the present invention;

FIG. 8 is an elevation view of the projection shown in FIG. 7;

FIG. 9 is a perspective view of a lower workpiece, a projection recently placed in the welding position, and a roll dispenser comprising a dispensing reel, a wound tape having a plurality of embedded projections therein, a projection ejector, and a receiving reel, in accordance with a preferred embodiment of the invention;

FIG. 10 is a side elevation view of a portion of the tape shown in FIG. 9;

FIG. 10a is a cross-section of the portion of tape shown in FIG. 10 taken along the line A-A; and

FIG. 11 is a perspective view of a lower workpiece, a projection and an encircling portion of tape recently placed in the welding position, and a roll dispenser comprising a dispensing reel, a wound tape having a plurality of embedded projections therein, a modified projection ejector and tape cutter, and a receiving reel, in accordance with a preferred embodiment of the invention.

### DETAILED DESCRIPTION OF THE INVENTION

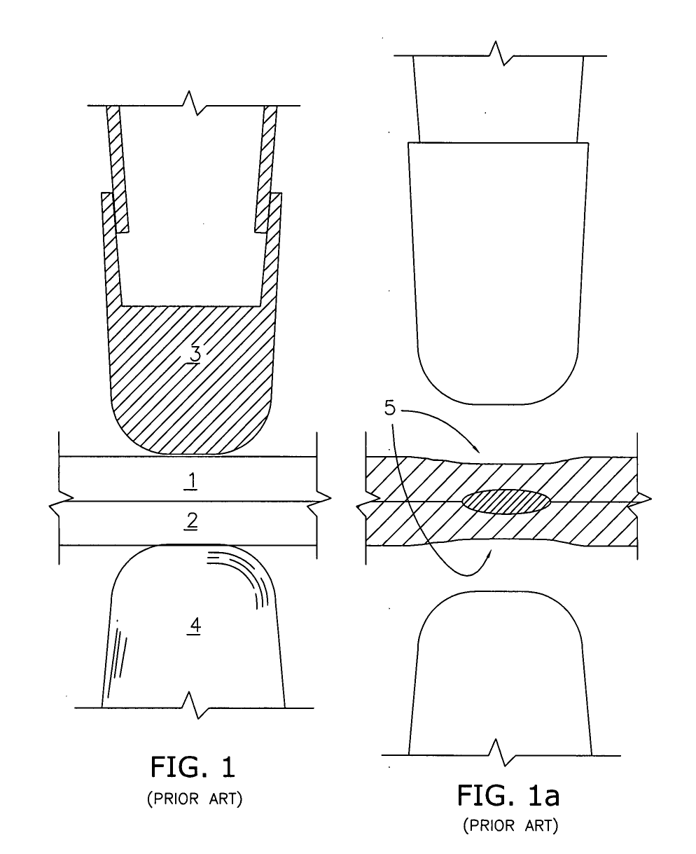

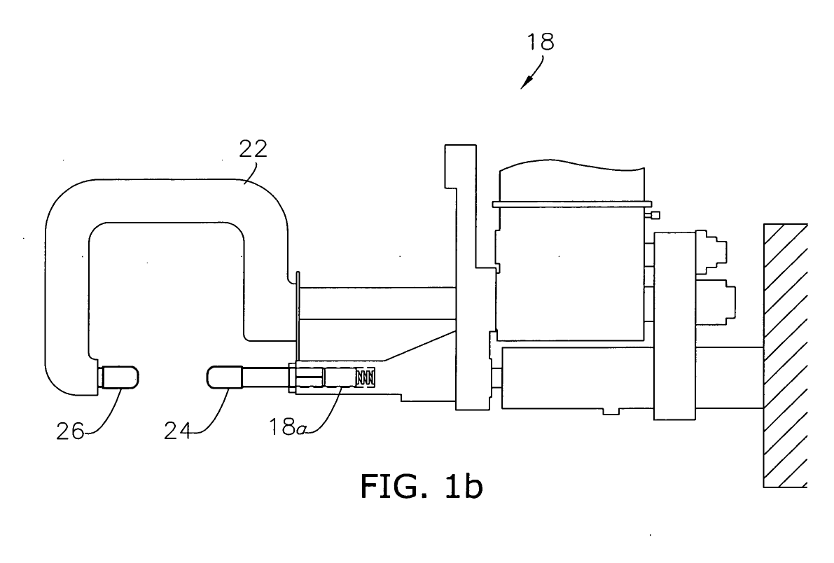

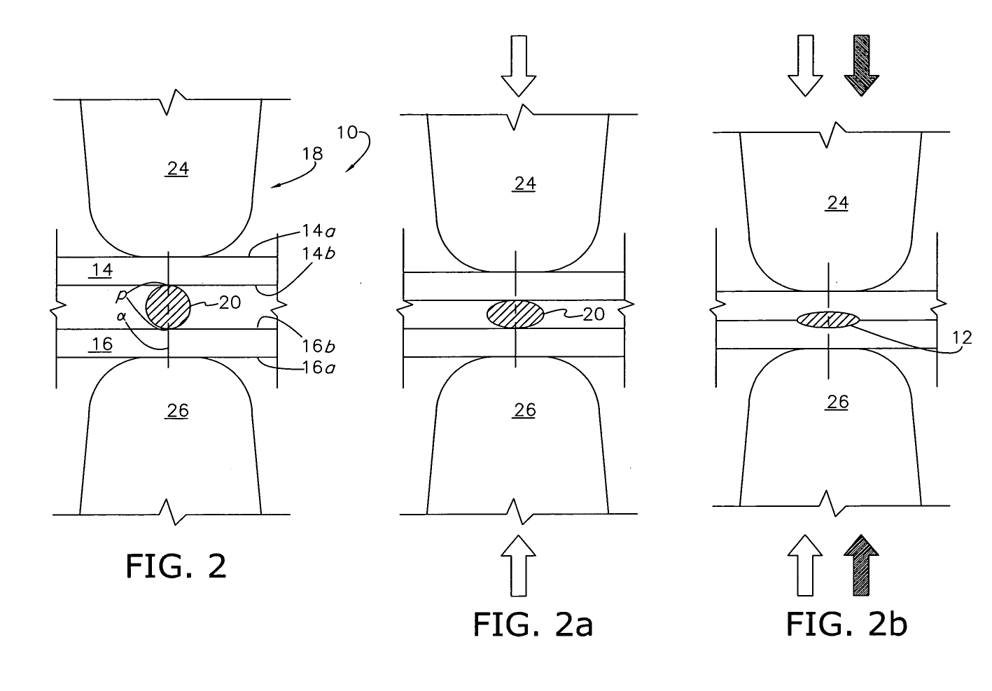

The present invention concerns a system 10 (FIGS. 2-11) for and method of producing an invisible spot or seam weld 12 (FIG. 2b) between a plurality of workpieces 14,16, such as a two-sheet “stack-up” of automotive sheet metal. The inventive system 10 is configured to produce the invisible weld 12 respective to the exterior of the constructed workpiece assembly (compare FIGS. 1a and 2b). That is to say, exterior surface deformations or anomalies, such as surface depressions, are not formed during the inventive resistance welding method described herein. It is appreciated that the invention, therefore, increases the aesthetic appeal and reduces the manufacturing costs of the assembled product. The invention is adapted for use with resistance mash welding devices, such as the apparatus 18 generally depicted in FIG. 1b, and does not require additional welding equipment and/or modifications except for the provision of a projection 20. The welding apparatus 18 preferably includes a fast follow-up cylinder 18a, is utilized, as it is appreciated that during welding it is imperative for the welding electrodes to follow the collapsing projection 20. That is to say, if the contact between workpiece 14,16 and electrodes is lost, an arc will be developed in the gap between electrode and the outer surface of the workpiece resulting in exterior surface anomalies or an ineffective weld. As exemplarily shown in FIG. 1b, the follow-up cylinder 18a preferably includes an air cylinder and spring interiorly connected and configured to further drive the cylinder, so as to provide the required follow up.

In the illustrated embodiments, a plurality of two workpieces 14,16 of equal thickness is shown; however, the inventive system 10 may be utilized to invisibly weld a greater plurality, or structural components having variable thickness or otherwise configuration by modifying and applying the teachings of the system 10 as required. The workpieces 14,16 preferably present planar configurations (FIGS. 2 and 4) defining generally flat surfaces and peripheral edges. The workpieces 14,16 may be formed of a wide range of metals, including steel and aluminum alloy. In the welding position, the workpieces 14,16 present oppositely engageable exterior surfaces 14a,16a, and interior surfaces 14b,16b apposite and parallel to the respective exterior surface (FIG. 2).

As illustrated and further described herein, the inventive weld 12 is produced by engaging at least one free-body projection 20 positioned intermediate the workpieces 14,16 with a resistance welding apparatus 18. The apparatus 18 may present a single-sided welding apparatus, so as to streamline the assembly process. In this configuration, a conductive backing block (not shown) may be provided to support the lower workpiece 16 either adjacent the weld 12 or at a convenient location away from the joint. If the workpieces 14,16 and projection 20 present sufficient stiffness, then a support is not necessary. More preferably, the system 10 includes a dual-electrode welding apparatus 18 (as generally shown in the illustrated embodiments), such as the type having a “C”-shaped structural frame 22 (FIG. 1b). In this configuration, the apparatus 18 includes a first electrode 24, a transport mechanism (also not shown), and an identical back-up electrode 26. As known in the art, the electrodes 24,26 oppositely engage the workpieces 14,16, to impart a welding force thereupon and complete an electric potential.

The electrodes 24,26 are preferably configured to contact the workpiece surfaces 14a,16a adjacent the projection 20, so as to maximize the applied force to and minimize the travel path of the current through the projection 20. Again, the follow-up cylinder 18a is provided to ensure that contact is maintained with the workpieces 14,16 as the projection fuses. Finally, as further described herein, the preferred apparatus 18 is operable to transmit the force and current load non-concurrently, wherein the force drive mechanism (also not shown) is actuated first.

Where seam welding is desired, the apparatus 18 includes wheel electrodes that rollingly engage the workpieces 14,16, as known in the art. The projection width is preferably less than the electrode wheel width, but a maximum lateral dimension is not defined. In this configuration, it is appreciated that elongated and even complex sinuous welds can be produced. It is also appreciated that the invention provides the added benefits of determining the precision of weld formation by the placement and configuration of the projection rather than by the accuracy of the electrode wheel path.

The interior surfaces 14b,16b of the workpieces are spaced by and abut the free-body projection 20. As a result, the projection 20 and workpieces 14,16 cooperatively define top and bottom points of contact, p, and at least one axis of engagement, α, passing through the points (FIG. 2). As previously mentioned, once the projection 20 has been properly positioned, and the workpieces 14,16 and projection 20 are secured in a relatively fixed condition (e.g., by clamping), the exterior surfaces 14a,16a are engaged by the welding apparatus 18, so as to transmit the force and current co-axially with the axis or axes of engagement. It is appreciated that an adhesive affixed to the projection 20 or the workpieces 14,16, or magnetism may be utilized to help retain the projection in the welding position (prior to clamping).

The preferred projection 20 and workpieces 14,16 are cooperatively configured such that the projection 20 deforms and completely fuses prior to any deformation of the workpieces 14,16 at or near their exterior surfaces 14a,16a. To that end, the projection 20 consists of material having a mean melting temperature less than that of the workpiece material(s); and more preferably less than ninety percent of the melting temperature of the workpiece material. Once molten, the projection 20 predominately forms the weld pool. It is appreciated, however, that a small quantity of workpiece material also fuses along the projection-workpiece interfaces, as part of a “wetting” process. The wetting process enables the formation of metallurgical bonds between the projection 20 and workpieces 14,16, and therefore presents a significant aspect of the invention.

Suitable projection materials include mild steel, aluminum alloys, silicon-bronze wire, or a combination thereof. The applied material is selected based upon the physical and chemical properties, including the relative “wettability,” hardness and melting temperatures, of the workpiece material(s). For example, where the workpiece material is electrogalvanized steel, a silicon-bronze projection 20 is preferably utilized, as it is appreciated that such combination of materials produce sufficient wetting along the projection-workpiece interfaces. In another example, where the workpieces 14,16 are formed of hard steel, the projection 20 preferably consists of mild steel having a 5 to 10 micron (i.e., 10⁻⁶ m) thick electrogalvanized zinc coating, as it is appreciated that the zinc coating facilely wets brazed workpiece material.

To further prevent exterior surface deformation, the projection 20 is configured so as to present minimal top and bottom projection-workpiece interfaces, as determinable by the lateral cross-section and length of the projection 20. Each projection-workpiece interface, pwi, presents an area substantially smaller than (e.g., less than twenty-five, and more preferably less than fifteen percent of) each of the electrode-workpiece interfaces, ewi (FIG. 4). The projection 20 preferably presents a width profile, as measured along its height, h, that maintains this ratio as the projection fuses. It is appreciated that the smaller areas of the projection-workpiece interfaces compared to the areas of the electrode-workpiece interfaces, result in greater pressure being exerted upon the projection 20. Further, it is appreciated that at the pwi areas resistance is substantially greater, and that as such, the majority of welding heat will be generated interiorly and away from the exterior workpiece surfaces. More preferably, to further increase this ratio, modified top and bottom electrodes 24a,26a (FIG. 4a) defining flat workpiece engaging surfaces substantially (e.g., 1.5 to 3 times) greater in diameter than those of standard size electrodes are utilized.

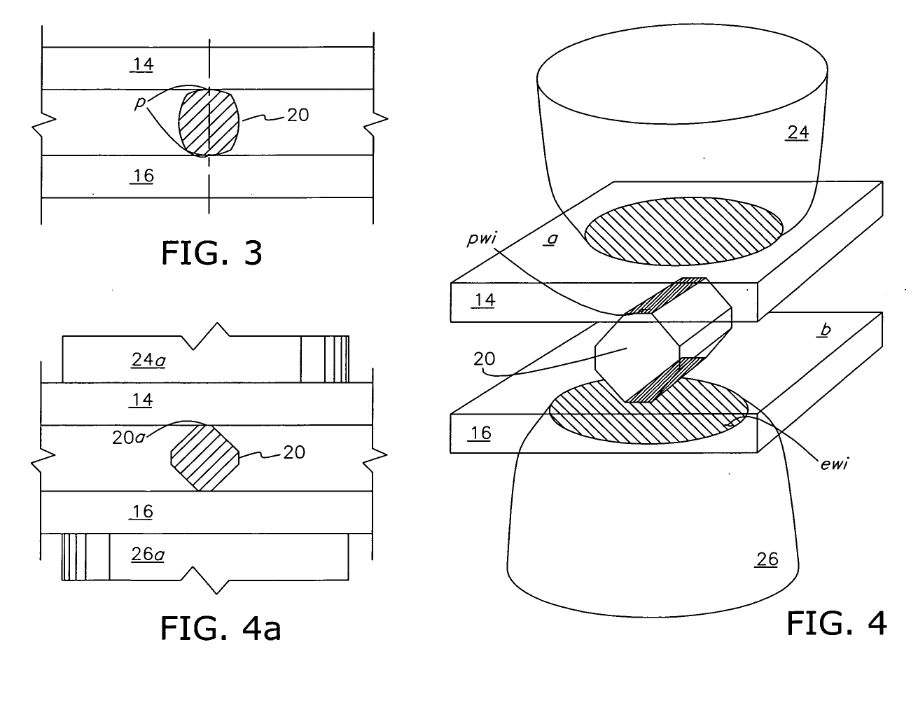

In one suitable configuration, the projection 20 presents curvilinear engagement surfaces providing singular points of contact, p. For example, the projection 20 may define a purely circular cross-section, as shown in FIG. 2. Alternatively, the curvilinear surfaces may be vertically spaced or elongated as shown in FIG. 3, so as to increase projection volume, maintain a single lateral point of contact, and reduce the maximum lateral projection width. It is appreciated that an initial single point of contact, as in a spherical or ellipsoidal projection 20 maximizes the pressure at and therefore minimizes the welding force required to initially deform the projection 20. Other projection configurations include polygonal cross-sectional shapes, such as the diamond configuration shown in FIGS. 4 and 4a. The edges of the diamond are preferably chamfered to present flat workpiece engaging surfaces 20a not more than 1 mm in width; and the projection 20 is oriented so as to engage the workpieces 14,16 along the flat engaging surfaces 20a.

The projection 20 further defines an overall longitudinal length, l (FIG. 7) that changes during fusion based on the longitudinal configuration of the projection versus the height of engagement. In this regard, it is appreciated that a segment of wire, for example, presents a generally constant 1, while a spherical projection 20 will present a constantly changing l as it fuses. The height (FIG. 8) and length (FIG. 7) of the projection 20 are sized to produce the desired weld joint size/area, and are more specifically determined based on the workpiece material and application. For example, where the workpieces 14,16 consists essentially of steel, the workpiece thickness is between 0.6 and 2 mm, and the application makes the provision of an effective joint highly critical, the projection length is preferably within the range 5 to 20 mm. More preferably, the projection length is approximately 9 mm for workpiece thickness within a range of from 0.6 to 1.2 mm, and approximately 12 mm within a range of 1.2 to 2 mm. The projection diameter is within the range 0.6 to 2 mm, and is more preferably 0.9 mm for workpiece thickness within the range 0.6 to 1.2 mm, and 1.4 mm for thickness within the range 1.2 to 2 mm.

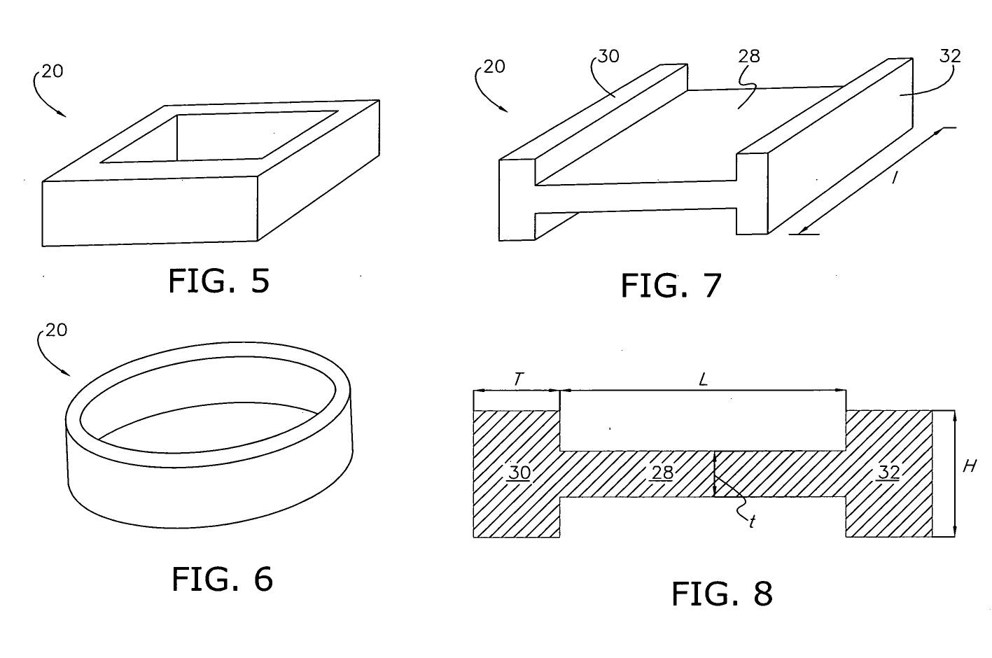

In another embodiment, the projection 20 may present an annular longitudinal configuration having a wall thickness within the range of 1 to 2 mm. Shown in FIGS. 5 and 6 are square and circular embodiments of this configuration. Where spot welding is to be performed, the annular projection 20 presents a maximum outside diameter at least 50 percent less than the minimum lateral dimension of the electrode-workpiece interfaces, ewi (FIG. 4). It is appreciated that in this configuration the weld footprint (i.e., effective area of the weld) is maintained, even though the amount of projection material to be fused, and therefore welding force and current load required are reduced.

Finally, in yet another embodiment shown in FIGS. 7 and 8, the projection 20 may present an “H”-shaped vertical cross-section formed by a cross member 28 that bisects and interconnects two preferably parallel outer members 30,32. In this configuration, the projection 20 is oriented so as to engage the workpieces 14,16 along the tops and bottoms of the parallel outer members 30,32. Thus, initial projection-workpiece interfaces, in this configuration, are limited to the wall thickness, T, and length, l. As shown in FIG.8, the cross member 28 presents a width, L, and a height or thickness, t; while the outer members 30,32 further present a height, H. More preferably, the cross member length and outer member height are cooperatively configured, such that L is equal to H times a multiple within the range of 3 to 8. For example, H may be within the range of 0.7 to 2 mm, T within the range of 0.5 to 1.5 mm, L within the range of 3 to 8 mm, t within the range of 0.2 to 0.5 mm, and l within the range of 5 to 20 mm.

In operation, the weld 12 is preferably formed by a welding apparatus 18 operable to transmit the welding force for a minimum period (e.g., 300 ms) prior to transmitting the current load (FIGS. 2-2b). As shown in intermediate FIG. 2a, it is appreciated that under a pure force load the projection 20 may undergo noticeable deformation, as occasioned by a harder workpiece material. More preferably, however, the projection 20 does not show deformation under the applied force load. It is appreciated that the generated stresses also facilitate fusion once the current load is applied, which thereby results in energy conservation. The force and current loads are then concurrently applied for a sustained period sufficient to fuse the projection 20 (e.g., 5 to 50 ms). Immediately upon the complete fusion of the projection 20, the force and current loads are terminated, so that deformation does not begin to form at the exterior surfaces 14a,16a (FIG. 2b). Both periods are preferably optimized through trial and error for a given application (i.e., set of variables) and recorded in a storage medium (not shown).

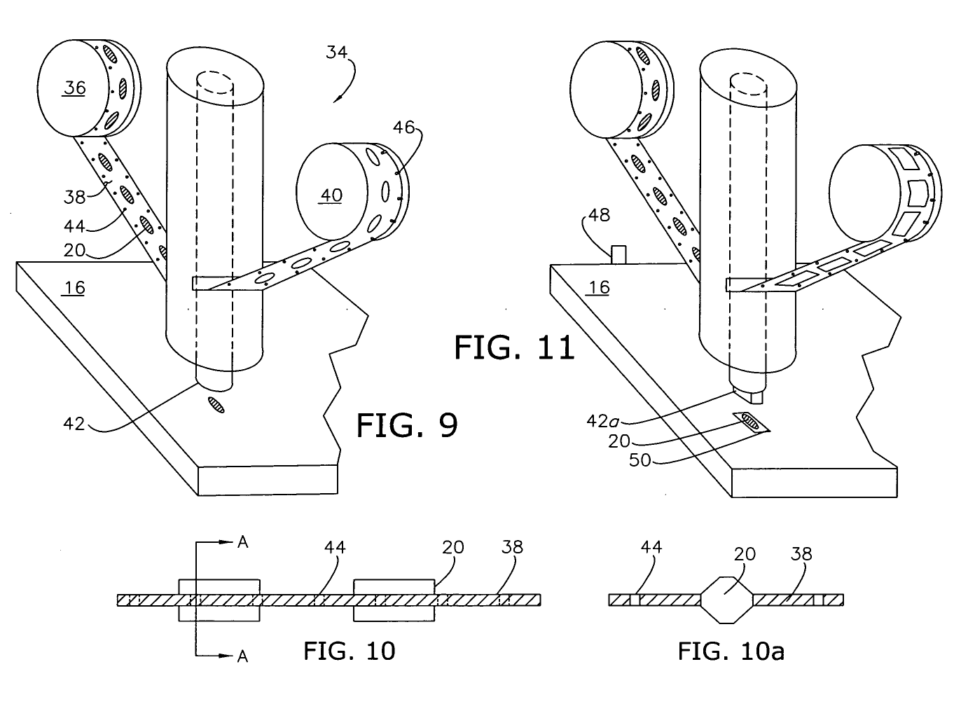

In a second mode of operation, the preferred system 10 is configured to autonomously position the projection 20 in an assembly-line setting; and to that end, includes a roll dispenser 34, such as the type used to place rivets during conventional rivet bonding applications. As shown in FIGS. 9-11, the roll dispenser 34 includes a dispensing reel 36 storing a wound tape 38 having a plurality of equally spaced embedded projections 20 therein, and a receiving reel 40. An ejector 42 is utilized to remove the projections from the tube (FIG. 9). The dispenser 34 is configured to translate into a placement position once the lower workpiece 16 has been properly secured, and out of the placement position once a projection 20 has been properly ejected and positioned. After the upper workpiece 14 is secured atop the projection 20, the weld 12 is produced, the joined workpieces 14,16 are removed, and a new lower workpiece 16 has been properly secured, the tape 38 is advanced one projection spacing, and the dispenser 34 is re-turned to the placement position. In an exemplary configuration (FIGS. 9-11), the tape 38 is advanced by drabbing a plurality of periphery holes 44 defined by the tape with prongs 46 presented by the receiving reel 40. The tape may be 10 to 15 mm wide and 0.5 mm thick.

Alternatively, a plurality of projections (e.g., 2 to 20) may be ejected and positioned when the dispenser 34 is in the placement position, where comprising a single joint. In another alternative, it is appreciated that the dispenser 34 may present a fixed station, wherein the workpiece and newly positioned projection 20 perform the translation.

The dispenser 34 and apparatus 18 are preferably programmably controlled, and present a closed-loop feedback control system 10. In this configuration, for example, the system 10 may further include at least one sensor 48 (FIG. 11) operable and oriented to detect whether the workpieces 14,16 and/or projection 20 has been properly positioned. The sensor 48 is communicatively coupled (e.g., connected by hard-wire or short-range wireless technology) to the dispenser 34 and apparatus 18 through a controller (not shown). It is appreciated that this facilitates a mass assembly process, wherein invisible projection welding is performed to join a large plurality of sets of workpieces over a welding period. Moreover, the system 10 may be programmably configured to access the storage medium, so as to recall previously determined optimized periods for a given application.

In a third mode of operation, the tape 38 is formed of material that forms an adhesive sealant when heated to a minimum temperature. In this configuration, the mode further includes positioning the projection 20 and an encircling portion 50 of the tape in the weld position. The portion 50 is produced, for example, by cutting the portion 50 from the remainder of the tape 38 with a modified ejector 42a (FIG. 11). The portion 50 is secured in the fixed condition in addition to the still embedded projection 20. When the workpieces 14,16 are engaged by the welding apparatus 18 to fuse the projection 20, the portion 50 is heated to the minimum temperature. As a result, an adhesive barrier is formed that completely encases the weld 12, and once cured during a finishing/painting process, further bonds the workpieces 14,16. Thus, it is appreciated that this configuration significantly increases the capacity of the joint and seals it from harmful impurities, such as moisture, oil, and dirt, and conditions, such as galvanic corrosion.

The preferred forms of the invention described above are to be used as illustration only, and should not be utilized in a limiting sense in interpreting the scope of the present invention. Obvious modifications to the exemplary embodiments and modes of operation, as set forth herein, could be readily made by those skilled in the art without departing from the spirit of the present invention. The inventor hereby states his intent to rely on the Doctrine of Equivalents to assess the scope of the present invention as pertains to any apparatus, system or method not materially departing from the literal scope of the invention set forth in the following claims.

What is claimed is:

1. A method of producing invisible welds for a plurality of workpieces utilizing a free-body projection to produce a weld joint, wherein each workpiece defines peripheral edges and an exterior engaging surface, said method comprising the steps of:
a. determining a selected free-body projection formed of a projection material and presenting a projection configuration, based on the chemical and physical properties of the workpieces;
b. positioning the projection in a welding position, wherein the projection intermediately abuts and is spaced from the peripheral edges of the workpieces;
c. securing the projection and workpieces in a fixed relative condition, when the projection is in the weld position, such that the projection and the workpieces cooperatively define at least one axis of engagement; and
d. oppositely engaging the exterior surfaces of the workpieces along the axis with a resistance welding apparatus, so as to deform and fuse only the projection.

2. The method as claimed in claim 1, wherein the projection presents a polygonal configuration, wherein the edges are chamfered so as to present a flat engaging surface not more than 1 mm in width, and orienting the projection so as to engage the workpieces along the flat engaging surfaces.

3. The method as claimed in claim 1, wherein the projection presents a cylindrical shape having a longitudinal depth and height, and defines curvilinear top and bottom surfaces and a plurality of axes of engagement.

4. The method as claimed in claim 1, wherein the projection is formed of material selected from the group consisting essentially of mild steel having an electrogalvanized zinc coating, aluminum alloys, and silicon-bronze wire.

5. The method as claimed in claim 1, wherein magnetism or an adhesive is utilized to retain the projection in the welding position.

6. The method as claimed in claim 1, wherein the projection presents a mean melting temperature less than ninety percent of the mean melting temperature of the workpieces.

7. The method as claimed in claim 1, wherein the projection laterally presents an annular configuration having a wall thickness within the range of 1 to 3 mm.

8. The method as claimed in claim 1, wherein the projection presents a spherical or ellipsoidal configuration.

9. The method as claimed in claim 8, wherein the workpieces are formed of hard steel, and the projection is formed of mild steel having a 5 to 10 micron thick electrogalvanized zinc coating.

10. The method as claimed in claim 1, wherein the projection presents an “H”-shaped vertical cross-section formed by a cross member and two parallel outer members, and is oriented so as to engage the workpieces along the tops and bottoms of the parallel outer members.

11. The method as claimed in claim 10, wherein the cross member presents a length, L, the outer members present a height, H, and L is equal to H times a multiple within the range of 3 to 8.

12. The method as claimed in claim 1, wherein step d) further includes the steps of engaging the workpieces with first and second welding electrodes along said at least one axis of engagement and transmitting a welding force and current load through the projection.

13. The method as claimed in claim 12, wherein the projection presents a longitudinal dimension, so as to define continuous axes of engagement, and the electrodes present electrode wheels configured to rollingly engage the workpieces along the axes of engagement.

14. The method as claimed in claim 12, wherein the workpieces and projection cooperatively define areas of projection-workpiece interface, and the electrodes and workpieces cooperatively define areas of electrode-workpiece interface greater than each of the areas of projection-workpiece interface.

15. The method as claimed in claim 14, wherein the electrodes each present enlarged workpiece engaging faces configured to further increase the areas of electrode-workpiece interface, and each of the areas of electrode-workpiece interface is greater than thrice the greater of the areas of projection-workpiece interface.

16. The method as claimed in claim 12, wherein step d) further includes the steps of transmitting the welding force through the projection for a first period prior to transmitting the current load.

17. The method as claimed in claim 16, wherein step d) further includes the steps of transmitting the force and load for a optimized second period after the first period.

18. A method of producing invisible welds for a plurality of workpieces utilizing a free-body projection to produce a weld joint, wherein each workpiece defines peripheral edges and an exterior engaging surface and presents a material fusion temperature and thickness, said method comprising the steps of:
a. determining a selected free-body projection formed of a projection material and presenting a projection configuration, wherein said material and configuration are based on the fusion temperatures and thickness of the workpieces;
b. positioning the projection in a desired weld position, wherein the projection is intermediate and spaced from the peripheral edges of the workpieces;
c. securing the projection and workpieces in a fixed relative condition, when the projection is in the weld position, such that the projection contacts the workpieces opposite their exterior surfaces and defines an axis of engagement; and
d. oppositely engaging the exterior surfaces of the workpieces along the axis with a resistance welding apparatus, wherein the apparatus includes enlarged flat workpiece engaging faces, and is operable to transmit through the projection a welding force for a first period and then the force and a current load for a second optimized period, so as to deform and fuse only the projection.

19. A method of producing invisible welds for a plurality of workpieces utilizing a free-body projection to produce a weld joint, wherein each workpiece defines peripheral edges and an exterior engaging surface, said method comprising the steps of:
a. determining a selected projection formed of a projection material and presenting a projection configuration, based on the chemical and physical properties of the workpieces;
b. securing a roll dispenser including a wound tape having a plurality of selected projections incrementally embedded therein in a first position relative to the first workpiece;
c. positioning a projection in a desired weld position intermediate and spaced from the peripheral edges of the first workpiece, by separating a selected projection from the tape;
d. securing the projection and workpieces in a fixed relative condition when the projection is in the weld position, such that the projection contacts the workpieces opposite their exterior surfaces and defines at least one axis of engagement; and
e. oppositely engaging the exterior engaging surfaces of the workpieces along said at least one axis with a resistance fusion welding apparatus, so as to deform and fuse only the projection.

20. The method as claimed in claim 19, wherein said tape is configured to form an adhesive sealant when heated to a minimum temperature, and steps b) through e) further include the steps of positioning the projection and an encircling portion of the tape in the weld position by cutting said portion from the remainder of the tape, further securing said portion of tape in the fixed condition, and engaging the workpieces with the apparatus so as to further heat said portion of tape.
